(19) United States
(12) Patent Application Publication
(10) Pub. No.: US 2016/0132191 A9
(43) Pub. Date: May 12, 2016

(54) APPARATUS CUSTOMIZATION

(71) Applicant: BRITA LP, Oakland, CA (US)

(72) Inventors: James R. Keys, Pleasanton, CA (US); Paul A. Walker, Pleasanton, CA (US)

(73) Assignee: Brita LP, Oakland, CA (US)

(21) Appl. No.: 13/855,941

(22) Filed: Apr. 3, 2013

Related U.S. Application Data
(62) Division of application No. 13/294,239, filed on Nov. 11, 2011, now abandoned.

(51) Int. Cl. G06F 3/0482

(52) U.S. Cl. CPC G06F 3/0482

(57) ABSTRACT

An apparatus, computer-implemented method for customizing an apparatus, and system for customizing an apparatus are disclosed. A user interface may allow a user to define content for customizing a selected apparatus. Based on the selected apparatus and the user-defined content, a label may be created that can be applied to the apparatus by a user. In this manner, an apparatus may be customized by applying and/or reapplying a label with user-defined content.

### CROSS REFERENCE TO RELATED APPLICATIONS

This application is a divisional of U.S. application Ser. No. 12/303,532, filed Dec. 4, 2008, which is incorporated herein in its entirety.

### BACKGROUND OF THE INVENTION

Allowing consumers to customize products is a growing trend in the marketplace. For example, covers with different colors or designs can be put on portable electronic devices. As another example, pens and other items can be personalized before shipment to the customer.

Many items cannot be customized in a convenient manner. For example, although apparatuses such as water pitchers or bottles can be written on, it is difficult to reproduce images or other customized content.

### SUMMARY OF THE INVENTION

Accordingly, a need exists to allow users to more easily and conveniently customize products. A need also exists to allow users to re-customize products or change the customization of products that have been previously customized. Additionally, a need exists to allow users to customize apparatuses such as water pitchers, water bottles, or the like. Embodiments of the present invention provide novel solutions to these needs and others as described below.

Embodiments of the present invention are directed to an apparatus, computer-implemented method for customizing an apparatus, and system for customizing an apparatus. More specifically, a user interface may allow a user to define content (e.g., one or more images, text, one or more colors, one or more holograms, etc.) for customizing a selected apparatus. Based on the selected apparatus and the user-defined content, a label may be created that can be applied to the apparatus by a user. In this manner, an apparatus may be customized by applying and/or reapplying a label with user-defined content.

The label may be removable in one embodiment. For example, the label may utilize static electricity or an adhesive which enables the label to be removed and/or reapplied. In this manner, the label may be removed and replaced with another label, thereby allowing the apparatus to be easily re-customized with little or no damage.

In one embodiment, an apparatus comprises a base and at least one wall coupled with the base. The at least one wall is operable to at least partially contain a water filter, wherein the at least one wall comprises at least one feature operable to interface with a label, wherein the label comprises customized content displayed thereon, and wherein the label is operable to be applied to the at least one wall to allow customization of the apparatus. The apparatus may also include the label in one embodiment.

In another embodiment, a computer-implemented method of customizing an apparatus includes accessing first data associated with a user selection of an apparatus. Second data associated with user-defined content for a label is accessed. At least one attribute for manufacturing the label with the user-defined content displayed thereon is determined, wherein the at least one attribute is determined based on the first data and the second data, and wherein the label is operable to be applied to the at least one wall to allow customization of the apparatus.

And in yet another embodiment, a system includes a processor and a memory, wherein the memory includes instructions that when executed by the system implement a method of customizing an apparatus, the method including accessing first data associated with a user selection of an apparatus. The method also includes accessing second data associated with user-defined content for a label. The method further includes determining at least one attribute for manufacturing the label with the user-defined content displayed thereon, wherein the determining further includes determining the at least one attribute based on the first data and the second data, and wherein the label is operable to be applied to the at least one wall to allow customization of the apparatus.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an apparatus before customization in accordance with one embodiment of the present invention.

FIG. 2 shows an apparatus after customization in accordance with one embodiment of the present invention.

FIG. 3 shows an apparatus with an exemplary indentation in accordance with one embodiment of the present invention.

FIG. 4 shows a label applied to or coupled with a feature in accordance with one embodiment of the present invention.

FIG. 5 shows a label applied to or coupled with a feature using a material in accordance with one embodiment of the present invention.

FIG. 6 shows a portion of an apparatus including a plurality of features in accordance with one embodiment of the present invention.

FIG. 7A shows a first portion of a flowchart of an exemplary computer-implemented process for customizing an apparatus in accordance with one embodiment of the present invention.

FIG. 7B shows a second portion of a flowchart of an exemplary computer-implemented process for customizing an apparatus in accordance with one embodiment of the present invention.

FIG. 8 shows an exemplary system for customizing an apparatus in accordance with one embodiment of the present invention.

FIG. 9 shows an exemplary on-screen graphical user interface for customizing an apparatus in accordance with one embodiment of the present invention.

FIG. 10 shows an exemplary computer system platform upon which embodiments of the present invention may be implemented.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing the terms such as “accepting,” “accessing,” “adding,” “analyzing,” “applying,” “assembling,” “assigning,” “associating,” “calculating,” “capturing,” “combining,” “communicating,” “comparing,” “collecting,” “creating,” “defining,” “depicting,” “detecting,” “determining,” “displaying,” “establishing,” “executing,” “filtering,” “generating,” “grouping,” “identifying,” “initiating,” “interacting,” “modifying,” “monitoring,” “moving,” “outputting,” “performing,” “placing,” “presenting,” “processing,” “programming,” “providing,” “querying,” “ranking,” “removing,” “repeating,” “sampling,” “sorting,” “storing,” “subtracting,” “transforming,” “using,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Embodiments of the Invention

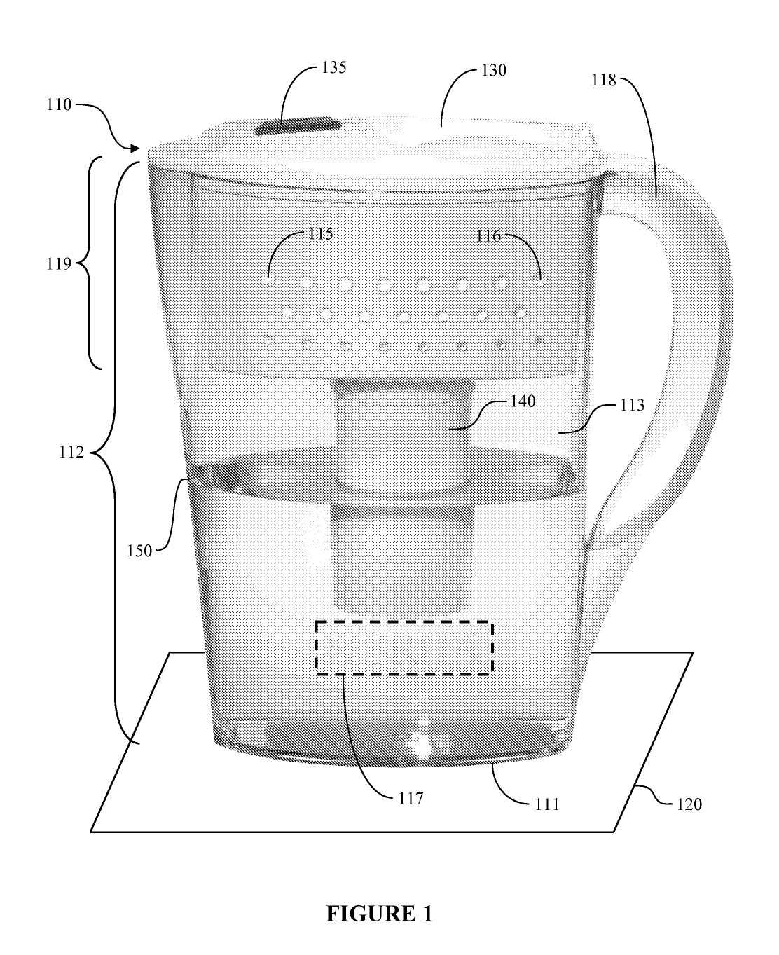

FIG. 1 shows vessel or apparatus 110 before customization in accordance with one embodiment of the present invention. As shown in FIG. 1, apparatus 110 (e.g., a pitcher, bottle, mug, etc.) includes first portion 111 (e.g., the base or bottom of the apparatus) and a second portion 112 (e.g., at least one wall), where each portion may include one or more respective surfaces. For example, first portion 111 may include a surface (e.g., a bottom surface of the apparatus) for interfacing and/or resting on another object or surface (e.g., 120). As another example, second portion 112 may include one or more surfaces (e.g., at least one outer surface 113, at least one inner surface, some combination thereof, etc.). In one embodiment, apparatus 110 may be customized by applying a label to one or more surfaces (e.g., 113, an inner surface, a bottom surface, another surface, etc.) of apparatus 110.

In one embodiment, one or more surfaces of apparatus 110 may be curved or otherwise non-planar. For example, surface 113 or at least one other surface may be curved or non-planar. In this manner, apparatus 110 may be customized by applying a label to a curved or non-planar surface of apparatus 110 in one embodiment.

Apparatus 110 may include provisions for a filter in one embodiment. For example, filter 140 may fit within upper portion 119 and filter a fluid (e.g., water) as the fluid passes from portion 119 into the lower portion of apparatus 110. In this manner, water may be poured into upper portion 119 so that it can be filtered (e.g., by filter 140) and collected in a lower portion of apparatus 110 (e.g., including first portion 111 and at least a portion of second portion 112).

In one embodiment, apparatus 110 may be a water pitcher. For example, water disposed in the lower portion of apparatus 110 may be poured from the apparatus (e.g., by tilting apparatus 110). The water may exit the apparatus through an opening defined in cover 130 and/or defined between cover 130 and second portion 112. In one embodiment, apparatus 110 may be held using handle 118, thereby enabling water to be more easily and conveniently poured from apparatus 110. Alternatively, a user may grasp the sides and/or bottom of apparatus 110 and pour the water from the apparatus.

Apparatus 110 may be a water bottle in one embodiment. For example, second portion 112 may be squeezed by a user to expel water from an opening defined in cover 130 and/or defined between cover 130 and second portion 112. Cover 130 may attach to second portion 112 using threads, a press or interference fit, etc. And in one embodiment, filter 140 may filter water as it exits from apparatus 110.

In one embodiment, the second portion (e.g., 112) may at least partially contain water filter 140. For example, water filter 140 may be at least partially disposed within the second portion (e.g., 112).

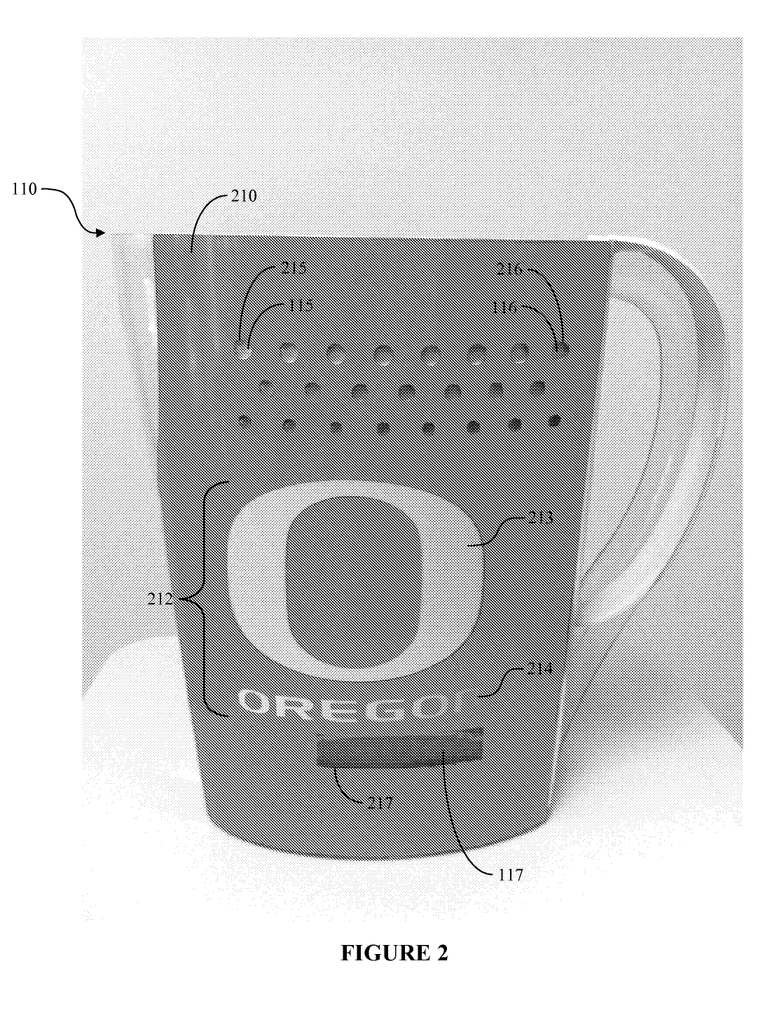

FIG. 2 shows apparatus 110 after customization in accordance with one embodiment of the present invention. As shown in FIG. 2, label 210 may be applied to and/or coupled with surface 113 of apparatus 110. Label 210 may be a decal, sticker, or any other object capable of being applied to and/or coupled with apparatus 110. Label 210 may be designed by a user and applied to apparatus 110 to customize and/or personalize apparatus 110.

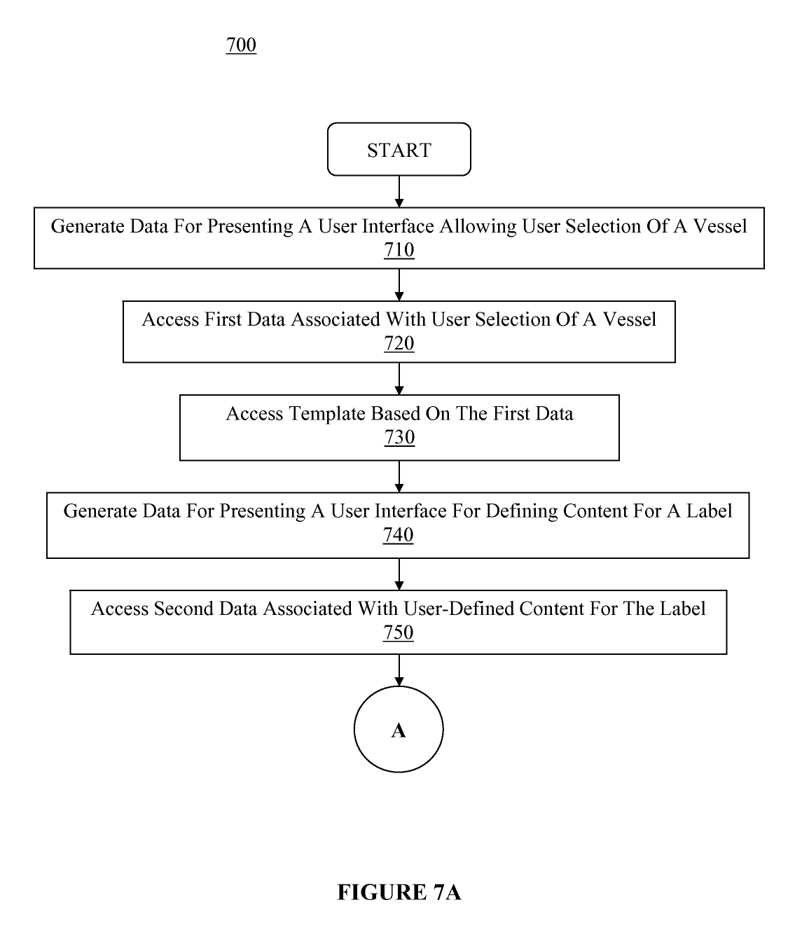

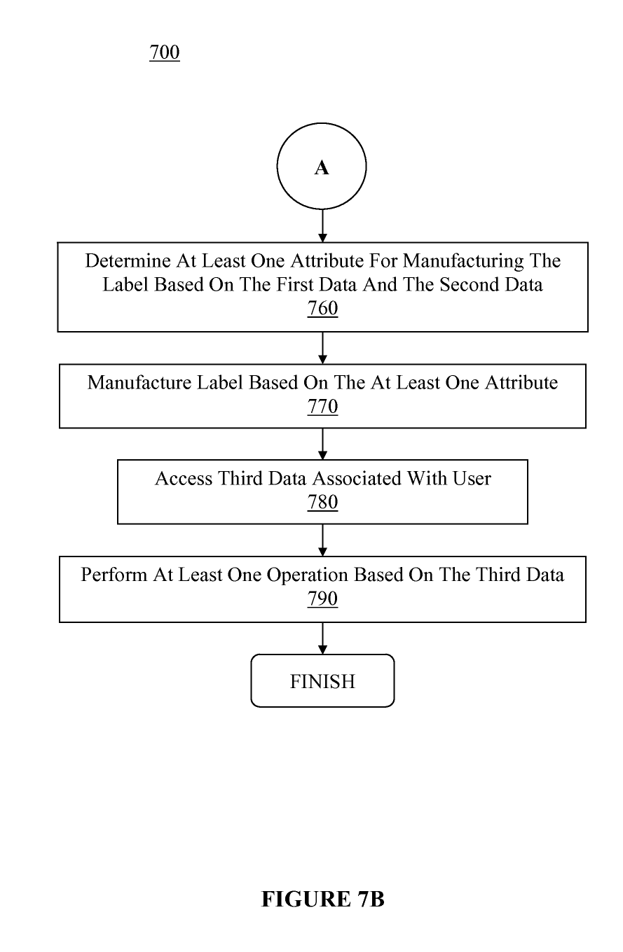

Label 210 may include content 212 in one embodiment. Content 212 may include at least one image (e.g., 213), text (e.g., 214), at least one color, at least one hologram, some combination thereof, etc. As such, embodiments of the present invention may increase the amount or degree to which an apparatus may be personalized or customized by allowing a user may specify or otherwise create content 212 for label 210 (e.g., in accordance with process 700 of FIGS. 7A and 7B).

Label 210 may be made from a polymer and/or another material. For example, label 210 may be made from vinyl, polyethylene terephthalate (PET), polyester, polypropylene, polylactic acid (PLA), polyacrylite, polyimide, polystyrene, polyolefin, paper, a laminate made from one or more of these materials, etc. Label 210 may adhere to surface 113 using static electricity, an adhesive, or the like. In this manner, label 113 may be removed from and/or applied to a surface of apparatus 110, thereby allowing apparatus 110 to be easily re-customized with little or no damage. In one embodiment, label 210 may be removed from apparatus 110 to allow another label (e.g., with different content than content 212) to be applied to apparatus 110.

Accordingly, embodiments of the present invention allow users to easily and conveniently customize an apparatus for one or more purposes. For example, an apparatus that contains food or drink for a child may be customized to include content that the child is familiar with (e.g., a favorite cartoon character or the like), thereby increasing the desirability of the apparatus's contents to the child by associating the apparatus's contents (e.g., food or drink) with the content of the label. As another example, the apparatus may be customized for a child's birthday party (e.g., to include the name of the child, the child's age, etc.) or other event. And as yet another example, at least one label may be applied to help distinguish apparatuses with similar characteristics (e.g., size, shape, color, etc.), which may be useful in the context of team sports, a refrigerator containing items of multiple people, etc.

Turning back to FIG. 1, apparatus 110 may include one or more features. For example, at least one feature (e.g., 115, 116, 117, etc.) may protrude or extend from surface 113. The at least one feature may form a pattern, a logo, a design, some combination thereof, etc. Additionally, in one embodiment, the at least one feature may be associated with and/or correspond to at least one opening of a label applied to apparatus 110.

As shown in FIG. 2, at least one opening defined in label 210 may interface and/or align with a respective feature of apparatus 110. For example, opening 215 may interface and/or align with feature 115, opening 216 may interface and/or align with feature 116, opening 217 may interface and/or align with feature 117, etc. In one embodiment, a feature (e.g., 115) may fit or extend at least partially within an opening (e.g., 215) of the label (e.g., when the label is applied to the apparatus). In this manner, the at least one opening (e.g., 215, 216, 217, etc.) may be used to locate the label (e.g., 210) on a surface of the apparatus, to enable the at least one feature to be viewable (e.g., through the at least one opening) while the label is applied to the apparatus (e.g., to display a logo or design while the label is applied, etc.), to enable the label to sit flush on surface 113, some combination thereof, etc.

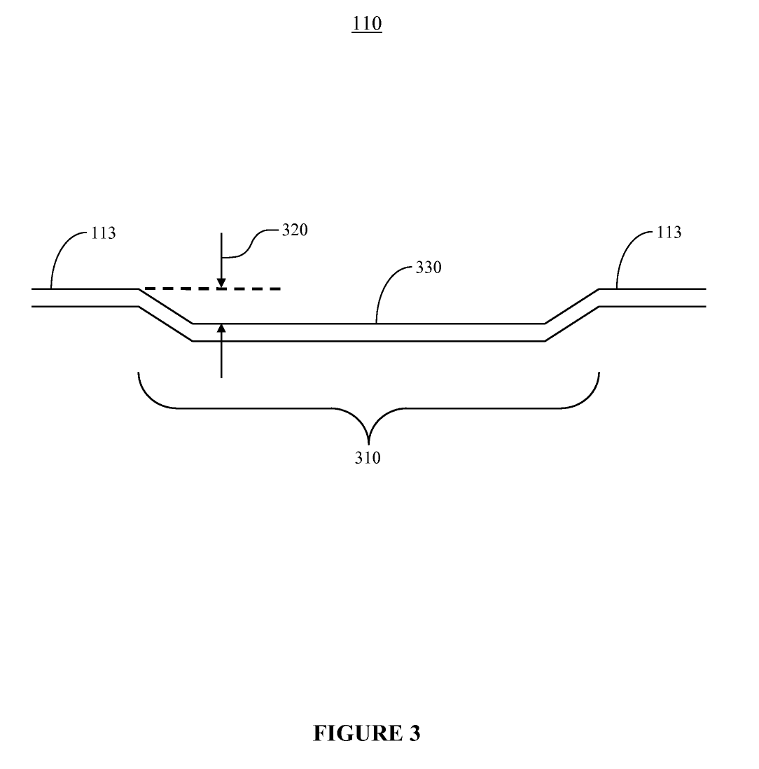

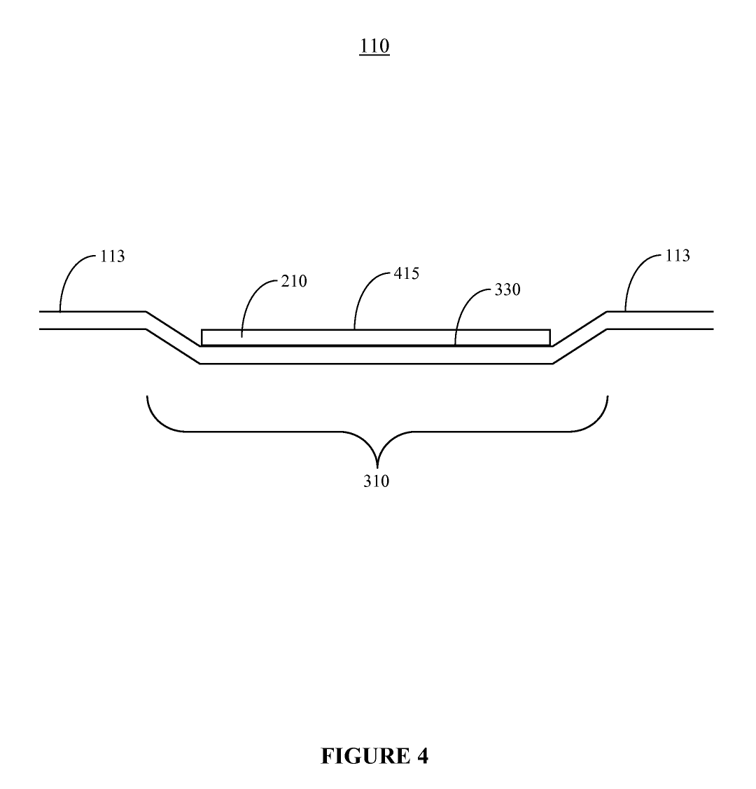

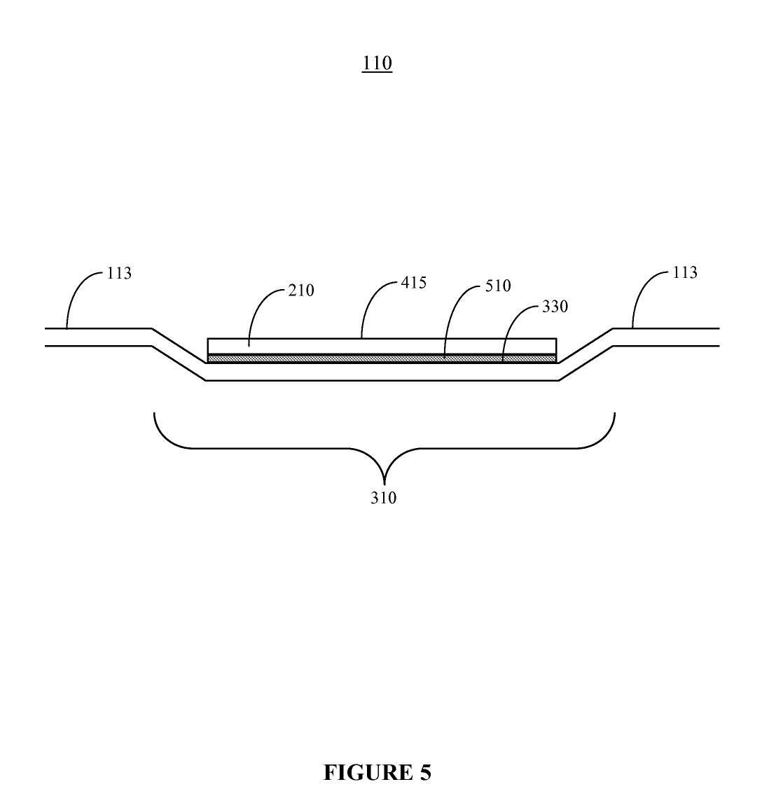

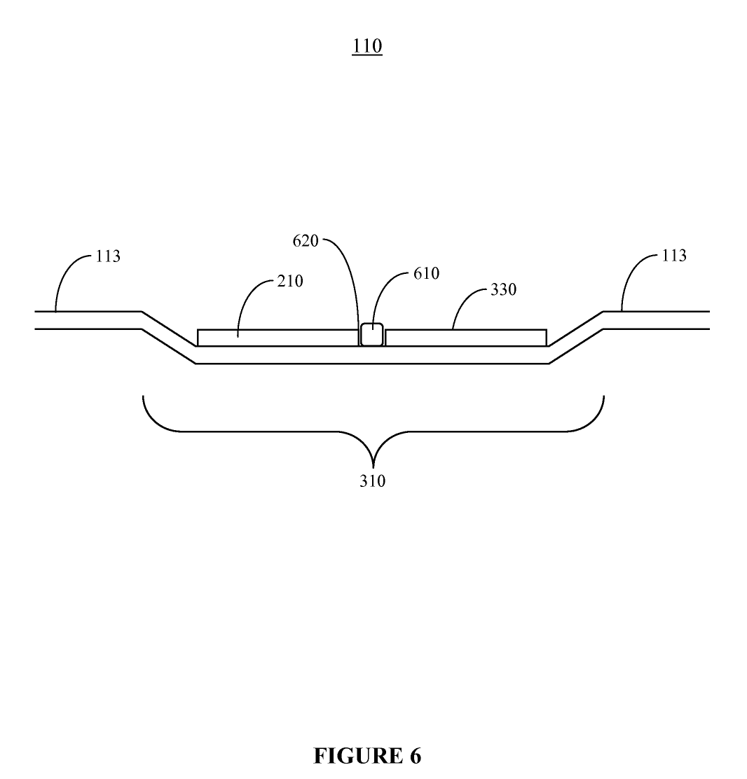

In one embodiment, apparatus 110 may include other types of features. For example, apparatus 110 may include at least one indentation (e.g., as depicted in FIG. 3, FIG. 4, FIG. 5, FIG. 6, etc.).

FIG. 3 shows apparatus 110 with an exemplary indentation in accordance with one embodiment of the present invention. As shown in FIG. 3, feature 310 may include an indentation with a depth 320. Depth 320 may be defined as the distance of surface 330 below surface 113 (or the plane formed by surface 113).

FIG. 4 shows label 210 applied to or coupled with feature 310 in accordance with one embodiment of the present invention. As shown in FIG. 4, label 210 may sit at least repartially within the indentation of feature 310. In one embodiment, surface 415 of label 210 may be positioned below surface 113 (or the plane formed by surface 113) while label 210 is applied to or coupled with apparatus 110. And in one embodiment, label 113 may be positioned above (e.g., extending beyond or protruding from) surface 113 (or the plane formed by surface 113) while label 210 is applied to or coupled with apparatus 110.

In one embodiment, label 210 may adhere to or couple with surface 330 of feature 310 using static electricity. In this case, label 210 may be referred to as a “static cling” label or the like. Label 210 may be disposed directly on (e.g., with no intervening layers or materials) surface 330 in one embodiment. Alternatively, label 210 may adhere to or coupled with surface 330 using an adhesive or other material disposed between label 210 and surface 330 (e.g., as depicted in FIG. 5).

FIG. 5 shows label 210 applied to or coupled with feature 310 using material 510 in accordance with one embodiment of the present invention. As shown in FIG. 5, material 510 may be disposed between label 210 and surface 330 of feature 310. Material 510 may be applied to label 210 and/or surface 330 before label 210 is applied to or coupled with surface 330. Material 510 may be an adhesive or some other material. In this manner, material 510 may secure label 210 to apparatus 110.

As shown in FIG. 5, label 210 may sit at least partially within the indentation of feature 310. In one embodiment, surface 415 of label 210 may be positioned below surface 113 (or the plane formed by surface 113) while label 210 is applied to or coupled with apparatus 110 using material 510. And in one embodiment, label 113 may be positioned above (e.g., extending beyond or protruding from) surface 113 (or the plane formed by surface 113) while label 210 is applied to or coupled with apparatus 110 using material 510.

FIG. 6 shows a portion of apparatus 110 including a plurality of features in accordance with one embodiment of the present invention. As shown in FIG. 6, feature 610 may protrude or extend from surface 330 of feature 310. In one embodiment, feature 610 may be one of a plurality of features that protrude or extend from surface 330. The at least one feature (e.g., 610, one or more other features protruding or extending from surface 330, etc.) may form a pattern, a logo, a design, some combination thereof, etc. Additionally, in one embodiment, the at least one feature (e.g., 610, one or more other features protruding or extending from surface 330, etc.) may be associated with and/or correspond to at least one opening of a label applied to apparatus 110.

As shown in FIG. 6, opening 620 defined in label 210 may interface and/or align with feature 610 of apparatus 110. In one embodiment, feature 610 may fit or extend at least partially within opening 620 of the label (e.g., when the label is applied to the apparatus). In this manner, opening 620 may be used to locate the label (e.g., 210) on a surface of the apparatus, to enable feature 610 to be viewable (e.g., through opening 620) while the label is applied to the apparatus (e.g., to display a logo or design while the label is applied, etc.), to enable the label to sit flush on surface 330, some combination thereof, etc.

In one embodiment, feature 310 may be configured to accept label 210. For example, feature 310 and label 210 may be similar in shape and/or label 210 may be shaped to fit within feature 310. As another example, depth 320 of feature 310 may be sized based on the thickness of label 210 (e.g., such that surface 415 sits approximately flush with surface 113, below surface 113, above surface 113, or in some other predetermined orientation with respect to surface 113).

In one embodiment, label 210 may be capable of changing colors responsive to a change in temperature. For example, a portion of label 210 disposed below the fluid level line (e.g., 150 of FIG. 1) may be at a different temperature than another portion of label 210 that is disposed above the fluid level line (e.g., 150 of FIG. 1). As such, label 210 may be used as a fluid level indicator by allowing a portion of the label to change color when the fluid level in apparatus 110 drops below a particular level. The level may be determined by the manufacturer (e.g., by configuring feature 310 to locate the label in approximately the same position each time it is applied) and/or by a user (e.g., by applying or coupling label 210 in different positions on apparatus 110).

In one embodiment, label 210 may change appearance over time. For example, the color of the label may change over time. As another example, one or more images on label 210 (e.g., content 212, etc.) may fade over time (e.g., to reveal another image, other content, etc.).

In one embodiment, the change in appearance of label 210 may encourage users to purchase another label and/or another component (e.g., filter 140, cover 130, etc.) for an associated apparatus (e.g., 110). For example, where a first image or content is displayed on label 210, label 210 may change appearance (e.g., due to a color change, fading of the first image, etc.) to reveal a second image or content that encourages users to replace label 210 and/or another component. As another example, the appearance of label 210 may degrade over time, thereby encouraging users to replace the label.

In one embodiment, a change in appearance may be implemented using a label (e.g., 210) that includes a plurality of layers. For example, an image or content of a first layer may fade, change color, etc. to reveal or otherwise change the appearance of an image or content on a second layer that is overlapped by the first layer. In one embodiment, the image or content of the second layer (e.g., that may be less visible initially or when label 210 is newer) may be a reminder to replace the label and/or another component (e.g., filter 140, cover 130, etc.), and thus, the replacement reminder may be displayed using label 210 after a period of time (e.g., after the image or content on the first layer fades, changes color, otherwise changes appearance, etc.).

In one embodiment, label 210 may be a multi-layer label with at least one removable layer. For example, an outer layer may include at least one image or content (e.g., 212), while an inner layer (e.g., overlapped by the outer layer) may include at least one other image or content (e.g., a coupon for a discounted decal or filter, other advertising information, other information including at least one image and/or text, etc.). In this manner, other information or content of (e.g., printed on, embedded in, etc.) an inner layer may be presented after an outer layer (e.g., including content 212) is at least partially removed (e.g., peeled back, peeled off, etc.). The information or content of the inner layer may encourage a user to replace the label, replace the filter, purchase another product associated with apparatus 110, etc.) in one embodiment. And in one embodiment, the outer layer may be reapplied to the inner layer or otherwise re-coupled with the apparatus (e.g., 110).

Label 210 may be purchased with a filter (e.g., 140) or another product (e.g., cover 130, etc.) associated with the same apparatus (e.g., 110) in one embodiment. For example, a user may purchase a subscription to a label or decal service (e.g., enabling a user to receive at least one label or decal automatically) and also receive at least one component (e.g., a filter, cover, another component associated with apparatus 110, etc.) free or at a discounted price. As such, a label (e.g., 210) and at least one other component associated with the same apparatus (e.g., 110) may be sold and/or incentivized in the same transaction.

Turning back to FIG. 1, apparatus 110 may be portable. For example, apparatus 110 may include handle 118. Handle 118 may be coupled or formed integrally with second portion 112 in one embodiment. In this manner, apparatus 110 may be carried using handle 118. Alternatively, where apparatus 110 does not include a handle, apparatus 110 may be carried by grasping second portion 112 using one or more hands.

As shown in FIG. 1, cover 130 may be placed on and/or secured to second portion 112. In one embodiment, cover 130 may include or otherwise be coupled to component 135. Component 135 may be used to indicate a life of filter 140 and/or to provide an indication to change filter 140 (e.g., after a predetermined period of use).

Apparatus 110 may be made from a polymer in one embodiment. Alternatively, apparatus 110 may be made from one or more other materials (e.g., metal, ceramic, etc.). And in one embodiment, apparatus 110 may be made from a combination of materials (e.g., at least one polymer, at least one metal, at least one ceramic, etc.).

Although FIGS. 1 and 2 depict apparatus 110 with a certain shape and configuration, it should be appreciated that apparatus 110 may be shaped and/or configured differently in other embodiments. For example, apparatus 110 may include no handle or a plurality of handles. As another example, apparatus 110 may include or be capable of interfacing with a cover or top that screws onto threads of the apparatus. As a further example, apparatus 110 may not include a filter in other embodiments. Further, although FIGS. 3 through 6 depict features of specific shapes and configurations, it should be appreciated that one or more features of apparatus 110 may be shaped and/or configured differently in other embodiments.

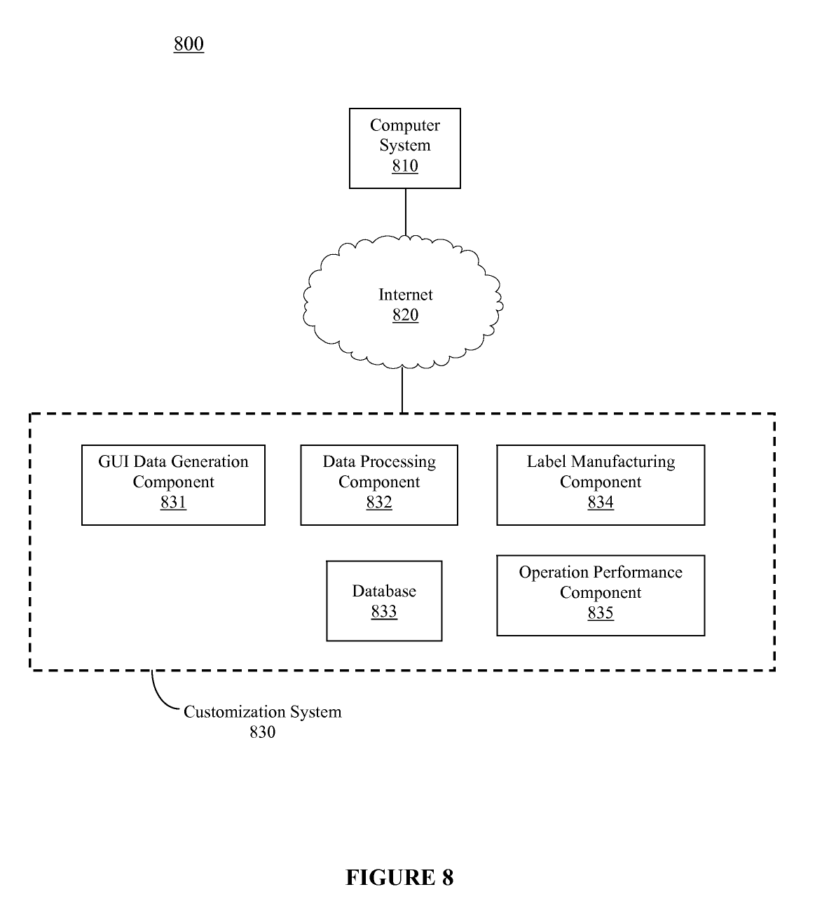

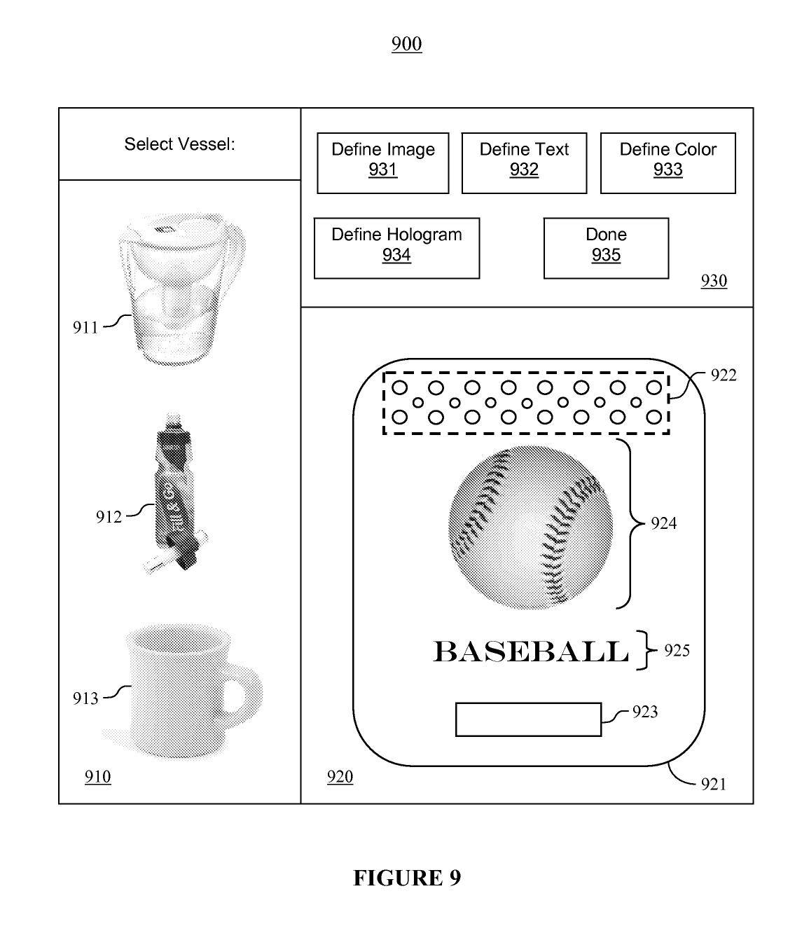

FIGS. 7A and 7B show a flowchart of exemplary computer-implemented process 700 for customizing an apparatus in accordance with one embodiment of the present invention. FIGS. 7A and 7B will be discussed in conjunction with FIG. 8 and FIG. 9 to provide examples and help clarify the discussion.

As shown in FIG. 7A, step 710 involves generating data for presenting a user interface allowing selection of an apparatus (e.g., 110). For example, data for presenting a user interface (e.g., region 910 of graphical user interface (GUI) 900 of FIG. 9) may be generated (e.g., by GUI data generation component 831 of customization system 830 of FIG. 8) in step 710. The data may be accessed (e.g., via Internet 820) and used to render one or more portions of GUI 900 (e.g., region 910, etc.) at computer system 810 (e.g., on a display device coupled thereto). In one embodiment, the data may include content (e.g., at least one image, audio data, video data, text, etc.), data for organizing the content and/or other portions of the user interface (e.g., frame data, position information associated with the content, etc.), data corresponding to the function of one or more portions of the user interface (e.g., how the user interface should respond to a given user interaction, etc.), etc.

Step 720 involves accessing first data associated with user selection of an apparatus. The selection may be made using a GUI (e.g., region 910 of GUI 900 of FIG. 9), where the GUI may include at least one apparatus (e.g., pitcher 911, water bottle 912, mug 913, etc.) for selection by a user. In one embodiment, the first data may be accessed (e.g., from computer system 810 via Internet 820) in step 720 by data processing component 832 of customization system 830.

As shown in FIG. 7A, step 730 involves accessing a template based on the first data (e.g., accessed in step 720). In one embodiment, the template may be accessed (e.g., from database 833) in step 730 by data processing component 832 of customization system 830. In one embodiment, the template may be specific to the selected apparatus associated with the first data. And in one embodiment, the template may specify one or more characteristics (e.g., the location, size, other characteristics, some combination thereof, etc.) of one or more features of the label (e.g., an outline of the label, at least one opening defined in the label, at least one region for adding content, some combination thereof, etc.). In this manner, the template may be used as a guide to assist the user in defining content (e.g., at least one image, text, at least one color, at least one hologram, some combination thereof, etc.) to be applied to the label.

Step 740 involves generating data for presenting a user interface for defining content for a label. For example, data for presenting a user interface (e.g., region 920 of GUI 900, region 930 of GUI 900, etc.) may be generated (e.g., by GUI data generation component 831 of customization system 830 of FIG. 8) in step 740. The data may be accessed (e.g., via Internet 820) and used to render one or more portions of GUI 900 (e.g., region 920, region 930, etc.) at computer system 810 (e.g., on a display device coupled thereto). In one embodiment, the data may include content (e.g., at least one image, audio data, video data, text, etc.), data for organizing the content and/or other portions of the user interface (e.g., frame data, position information associated with the content, etc.), data corresponding to the function of one or more portions of the user interface (e.g., how the user interface should respond to a given user interaction, etc.), etc.

In one embodiment, the data generated in step 740 may be generated based on the template accessed in step 730. For example, region 921 may be a visual depiction of a label that can be customized by a user, where region 921 may be sized and/or shaped based on the template (e.g., specific to an apparatus associated with the template). As another example, regions 922 and 923 may indicate openings defined in the label, where characteristics (e.g., size, shape, location, etc.) of the openings may be determined based on the template (e.g., specific to an apparatus associated with the template). And as yet another example, regions 924 and 925 may indicate regions capable of accepting content, where characteristics (e.g., size, shape, location, etc.) of the regions may be determined based on the template (e.g., specific to an apparatus associated with the template).

In one embodiment, content (e.g., at least one image, text, at least one color, at least one hologram, some combination thereof, etc.) may be defined using region 930 of GUI 900. For example, a user may interact with region 931 to define (e.g., add, edit, delete, resize, etc.) one or more images to be applied to the label depicted in region 921. Region 932 may be used to define (e.g., add, edit, delete, resize, etc.) text to be applied to the label depicted in region 921. As another example, a user may interact with region 933 to define (e.g., add, edit, delete, etc.) one or more colors to be applied to the label depicted in region 921. Region 934 may be used to define (e.g., add, edit, delete, resize, etc.) one or more holograms to be applied to the label depicted in region 921.

GUI 900 may also be used to determine the position of and/or further define any content added to the label depicted in region 921. For example, a user may drag an image, text or other content from one location to another. As another example, a user can resize content by dragging a corner of content, by initiating a multi-touch command (e.g., by moving one's fingers apart over an image to increase the size of the image, by moving one's fingers together over an image to decrease the size of the image, etc.), etc. Accordingly, GUI 900 provides convenient mechanisms for allowing users to easily define content to be applied to a label.

As shown in FIG. 9, region 935 may be used to save changes, initiate payment, submit the label for manufacturing, some combination thereof, etc. In one embodiment, data associated with the label and/or customization thereof may be saved (e.g., locally on computer system 810, in database 833, etc.) for future access (e.g., by computer system 810).

Turning back to FIG. 7A, step 750 involves accessing second data associated with user-defined content for the label. For example, the second data may include information (e.g., size, shape, location, appearance, pixel data, etc.) about content (e.g., at least one image, text, at least one color, at least one hologram, some combination thereof, etc.) defined using GUI 900. In one embodiment, the second data may be accessed (e.g., from computer system 810 via Internet 820) in step 750 by data processing component 832 of customization system 830.

As shown in FIG. 7B, step 760 involves determining at least one attribute for manufacturing the label based on the first data (e.g., accessed in step 720) and the second data (e.g., accessed in step 750). The at least one attribute may include information about the label as a whole (e.g., the size, shape, color, etc.), information about the content to be applied to the label (e.g., a respective location of each piece of content, a respective size of each piece of content, respective pixel data for each piece of content, etc.), information about features (e.g., openings, etc.) of the label (e.g., a respective location of each feature, a respective size of each feature, etc.), some combination thereof, etc. In one embodiment, step 760 may involve determining the at least one attribute based at least in part on the template (e.g., accessed in step 730). And in one embodiment, step 760 may be performed by data processing component 832 of customization system 830.

Step 770 involves manufacturing the label based on the at least one attribute (e.g., determined in step 760). The label may be manufactured by label manufacturing component 834 of customization system 830 in one embodiment.

As shown in FIG. 7B, step 780 involves accessing third data associated with a user. The third data may include information such as name, address, types of apparatuses owned by the user, date of purchase of the apparatuses, etc. In one embodiment, the third data may be collected from the user using GUI 900. And in one embodiment, the third data may be collected from the user as part of a registration process for gaining access to GUI 900. Step 780 may be performed by data processing component 832 of customization system 830 in one embodiment.

Step 790 involves performing at least one operation based on the third data. For example, step 790 may involve shipping the label to the user based on the at least a portion of the third data (e.g., name, address, etc.). As another example, step 790 may involve delivering a communication (e.g., a targeted communication) to the user based on at least a portion of the third data (e.g., name, address, types of apparatuses owned by the user, date of purchase of the apparatuses, etc.), where the communication may be a reminder to order or change the filter in the apparatus, information about one or more products related to an apparatus owned by the user, coupons or other promotional information associated with an apparatus owned by the user, etc. In one embodiment, step 790 may be performed by operation performance component 835 of customization system 830.

Turning back to FIG. 8, database 833 may be used to store one or more types of data. For example, database 833 may store the first data (e.g. accessed in step 720), the second data (e.g., accessed in step 750), the third data (e.g., accessed in step 780), or some combination thereof. As another example, database 833 may store one or more templates (e.g., accessed in step 730). And as yet another example, database 833 may store one or more types of other data associated with process 700.

In one embodiment, one or more components of system 800 may be owned and/or operated by an entity separate from the manufacturer of the apparatus (e.g., 110). And in one embodiment, one or more components of system 800 may be owned by different entities, located remotely from one another, some combination thereof, etc.

Although FIG. 8 depicts system 800 with a specific number and arrangement of components, it should be appreciated that system 800 may include a different number and/or arrangement of components in other embodiments. For example, one or more components may be combined, a component may be split into two or more sub-components, etc.

Although FIG. 9 depicts GUI 900 with a specific number and arrangement of regions, it should be appreciated that GUI 900 may include a different number and/or arrangement of regions in other embodiments. Additionally, although FIG. 9 depicts GUI 900 with a specific size and shape of regions, it should be appreciated that GUI 900 may include a different size and/or shape of regions in other embodiments.

### Computer System Platform

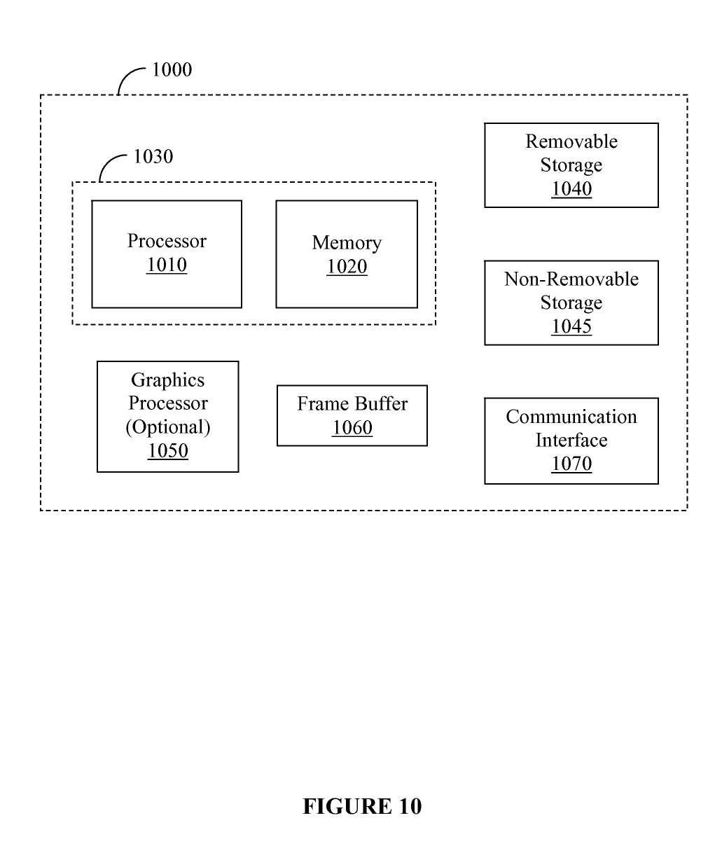

FIG. 10 shows exemplary computer system platform 1000 upon which embodiments of the present invention may be implemented. As shown in FIG. 10, portions of the present invention may be implemented by execution of computer-readable instructions or computer-executable instructions that may reside in components of computer system platform 1000 and which may be used as a part of a general purpose computer network. It is appreciated that computer system platform 1000 of FIG. 10 is merely exemplary. As such, the present invention can operate within a number of different systems including, but not limited to, general-purpose computer systems, embedded computer systems, laptop computer systems, hand-held computer systems, portable computer systems, or stand-alone computer systems.

In one embodiment, computer system platform 1000 may be used to implement computer system 810, customization system 830 (or at least one component thereof), some combination thereof, etc. And in one embodiment, one or more components of computer system platform 1000 may be disposed in and/or coupled with a housing or enclosure.

In one embodiment, depicted by dashed lines 1030, computer system platform 1000 may include at least one processor 1010 and at least one memory 1020. Processor 1010 may include a central processing unit (CPU) or other type of processor. Depending on the configuration and/or type of computer system environment, memory 1020 may include volatile memory (e.g., RAM), non-volatile memory (e.g., ROM, flash memory, etc.), or some combination of the two. Additionally, memory 1020 may be removable, non-removable, etc.

In other embodiments, computer system platform 1000 may include additional storage (e.g., removable storage 1040, non-removable storage 1045, etc.). Removable storage 1040 and/or non-removable storage 1045 may include volatile memory, non-volatile memory, or any combination thereof. Additionally, removable storage 1040 and/or non-removable storage 1045 may include CD-ROM, digital versatile disks (DVD) or other optical storage, magnetic cassettes, magnetic tape, magnetic disk storage or other magnetic storage devices, or any other medium which can be used to store information for access by computer system platform 1000.

As shown in FIG. 10, computer system platform 1000 may communicate with other systems, components, or devices via communication interface 1070. Communication interface 1070 may embody computer-readable instructions, data structures, program modules or other data in a modulated data signal (e.g., a carrier wave) or other transport mechanism. By way of example, and not limitation, communication interface 1070 may couple to wired media (e.g., a wired network, direct-wired connection, etc.) and/or wireless media (e.g., a wireless network, a wireless connection utilizing acoustic, radio frequency (RF), infrared, or other wireless signaling, etc.).

Communication interface 1070 may also couple computer system platform 1000 to one or more input devices (e.g., a keyboard, mouse, pen, voice input device, touch input device or touch screen, etc.). In one embodiment, communication interface 1070 may couple computer system platform 1000 to one or more output devices (e.g., a display, speaker, printer, etc.).

As shown in FIG. 10, graphics processor 1050 may perform graphics processing operations on graphical data stored in frame buffer 1060 or another memory (e.g., 1020, 1040, 1045, etc.) of computer system platform 1000. Graphical data stored in frame buffer 1060 may be accessed, processed, and/or modified by components (e.g., graphics processor 1050, processor 1010, etc.) of computer system platform 1000 and/or components of other systems/devices. Additionally, the graphical data may be accessed (e.g., by graphics processor 1050) and displayed on an output device coupled to computer system platform 1000. Accordingly, memory 1020, removable storage 1040, non-removable storage 1045, fame buffer 1060, or a combination thereof, may be a computer-readable medium or computer-usable medium and may include instructions that when executed by a processor (e.g., 1010, 1050, etc.) implement a method of customizing an apparatus (e.g., in accordance with process 700 of FIG. 7A and/or FIG. 7B), some combination thereof, etc.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A computer-implemented method of customizing an apparatus, said method comprising:
accessing first data associated with a user selection of an apparatus;
accessing second data associated with user-defined content for a label; and
determining at least one attribute for manufacturing said label with said user-defined content displayed thereon, wherein said determining further comprises determining said at least one attribute based on said first data and said second data, and wherein said label is operable to be applied to said at least one wall to allow customization of said apparatus.

2. The method of claim 1, wherein said user-defined content is selected from a group consisting of an image, text, and a color.

3. The method of claim 1 further comprising:
generating data for presenting a first user interface allowing user selection of said apparatus; and
generating data for presenting a second user interface for defining said user-defined content.

4. The method of claim 1 further comprising:
accessing a template based on said first data, wherein said template is specific to said apparatus, and wherein said template is operable to specify at least one characteristic of at least one feature of said label, and
wherein said generating data for presenting said second user interface further comprises generating data for presenting said second user interface based on said template.

5. The method of claim 1, wherein said first and second user interfaces are graphical user interfaces.

6. The method of claim 1, wherein said at least one attribute is selected from a group consisting of a size of said label, a shape of said label, a material of said label, a location of at least one opening defined in said label, a location of said user-defined content on said label, and an appearance of said user-defined content on said label.

7. The method of claim 1 further comprising:
accessing third data associated with a user; and
performing at least one operation based on said third data.

8. A system comprising a processor and a memory, wherein said memory comprises instructions that when executed by said system implement a method of customizing an apparatus, said method comprising
accessing first data associated with a user selection of an apparatus;
accessing second data associated with user-defined content for a label; and
determining at least one attribute for manufacturing said label with said user-defined content displayed thereon, wherein said determining further comprises determining said at least one attribute based on said first data and said second data, and wherein said label is operable to be applied to said at least one wall to allow customization of said apparatus.

9. The system of claim 8, wherein said user-defined content is selected from a group consisting of an image, text, and a color.

10. The system of claim 8, wherein said method further comprises:
generating data for presenting a first user interface allowing user selection of said apparatus; and
generating data for presenting a second user interface for defining said user-defined content.

11. The system of claim 8, wherein said method further comprises:
accessing a template based on said first data, wherein said template is specific to said apparatus, and wherein said template is operable to specify at least one characteristic of at least one feature of said label, and
wherein said generating data for presenting said second user interface further comprises generating data for presenting said second user interface based on said template.

12. The system of claim 8, wherein said first and second user interfaces are graphical user interfaces.

13. The system of claim 8, wherein said at least one attribute is selected from a group consisting of a size of said label, a shape of said label, a material of said label, a location of at least one opening defined in said label, a location of said user-defined content on said label, and an appearance of said user-defined content on said label.

14. The system of claim 8, wherein said method further comprises:
accessing third data associated with a user; and
performing at least one operation based on said third data.
